(19) United States
(12) Patent Application Publication
(10) Pub. No.: US 2019/0286751 A1
(43) Pub. Date: Sep. 19, 2019

(54) Systems and Methods for Adaptive Goal-Oriented Learning Paths

(71) Applicant: Gooru, Inc., Redwood City, CA (US)

(72) Inventor: Prasad Ram, Los Altos, CA (US)

(73) Assignee: Gooru, Inc., Redwood City, CA (US)

(21) Appl. No.: 16/004,690

(22) Filed: Jun. 11, 2018

Related U.S. Application Data
(60) Provisional application No. 62/643,639, filed on Mar. 15, 2018.

(51) Int. Cl. G06F 17/30; G09B 5/06; G06F 11/34

(52) U.S. Cl. CPC G06F 17/30867; G09B 5/06; G06F 17/30958; G06F 17/30994; G06F 11/3438

(57) ABSTRACT

Disclosed herein are system, method, and computer program product embodiments for providing adaptive learning paths based on specified learning goals and student competency. An embodiment operates by receiving a learning objective associated with a user and retrieving from one or more storage devices a competency profile associated with the user. The competency profiles comprise information representing a current competency of the user regarding concepts associated with the learning objective. Then system then selects, based on a concept dependency graph, an ordered set of learning activities that establish a path between the current proficiency and the learning objective. References to the learning activities are stored in a learning activities table associated with the concepts in the concept dependency graph. The system then sends information related to the learning activities to the user.

### BACKGROUND

### Technical Field

Embodiments generally relate to computerized educational systems and methods.

### Background

Traditionally, education has focused on the learning “destination.” Teachers teach courses according to established curricula and standards set by government agencies or educational institutions. Students take exams and complete assignments to assess their mastery of the subject matter, again as directed by established standards. In general, educational standards are met via two main activities. First, learning occurs in a classroom environment where multiple students learn along the same path and at the same pace, with the ability to interact and support each other. Second, learning activities are typically well-structured in textbooks or a variety of online applications/courses. Well-structured mechanisms for learning have allowed students to manage their pace, interact with a community, and even adapt the content based on learner's performance. However, while these fixed-path approaches have served a fortunate few, they have fallen short for the majority of people.

### SUMMARY

Disclosed herein are system, method, and computer program product embodiments for providing adaptive learning paths based on specified learning goals and student competency profiles. An embodiment operates by receiving a learning objective associated with a user and retrieving a competency profile associated with the user. The competency profile includes information representing a current proficiency of the user regarding concepts associated with the learning objective. Based on a concept dependency graph, the system determines an ordered set of learning activities that establish a path between the current proficiency and the learning objective. The user is then presented with information related to the learning activities.

### BRIEF DESCRIPTION OF THE DRAWINGS

The accompanying drawings are incorporated herein and form a part of the specification.

FIG. 1 illustrates an educational system environment, according to an example embodiment.

FIG. 2 is a flowchart of a method for providing adaptive learning paths based on specified learning goals and student competency profiles, according to an example embodiment.

FIG. 3 is a flowchart of a method for providing suggestions and assessments for generating adaptive learning paths, according to an example embodiment.

FIG. 4 is a block diagram describing a subject matter competency model, according to an example embodiment.

FIG. 5 is a block diagram describing the generating and presentation of suggestions and route planning for an adaptive learning path, according to an example embodiment.

FIG. 6 is a diagram describing a concept competency map, according to an example embodiment.

FIG. 7 shows a user interface for gathering competency profile data, according to an example embodiment.

FIG. 8 shows a user interface for navigating an educational content portal, according to an example embodiment.

FIG. 9 shows a user interface for navigating educational content offerings and learning routes, according to an example embodiment.

FIG. 10 shows additional details of a user interface for navigating educational content offerings and learning routes, according to an example embodiment.

FIG. 11 shows additional details of a user interface for navigating educational content offerings and learning routes, according to an example embodiment.

FIG. 12 shows a user interface for accessing an adaptive learning route, according to an example embodiment.

FIG. 13 shows a list-view user interface for tracking progress of an adaptive learning route, according to an example embodiment.

FIG. 14 shows a user interface for managing content preferences of an adaptive learning route, according to an example embodiment.

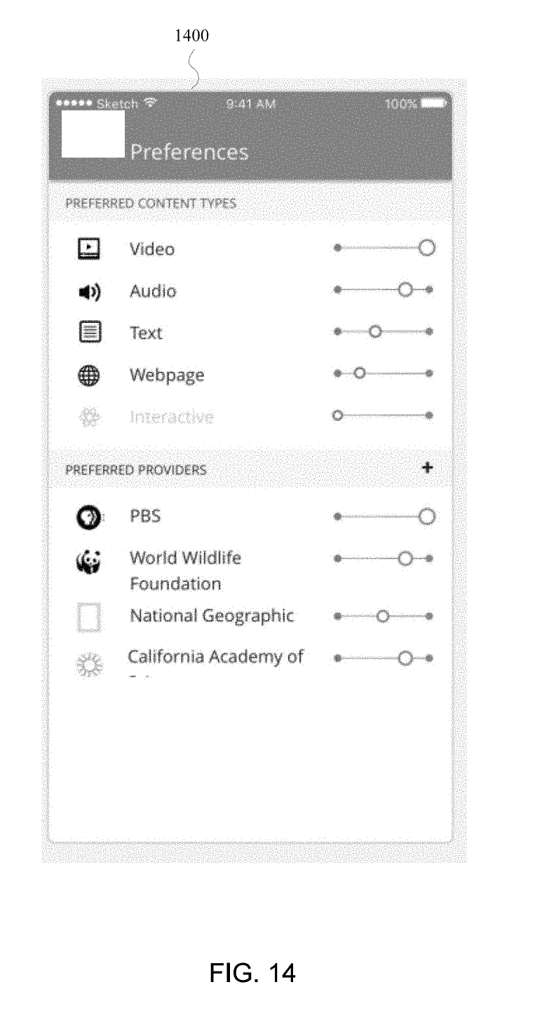

FIG. 15 shows a user interface for refining an adaptive learning route, according to an example embodiment.

FIG. 16 shows a user interface for receiving suggestions for learning resources and routes, according to an example embodiment.

FIG. 17 shows a user interface for viewing a concept proficiency matrix, according to an example embodiment.

FIG. 18 shows a user interface for communicating and sharing content with other users of a learning environment, according to an example embodiment.

FIG. 19 shows further details of user interface for communicating and sharing content with other users of a learning environment, according to an example embodiment.

FIG. 20 shows a user interface for providing feedback related to a learning experience, according to an example embodiment.

FIG. 21 shows a user interface for providing an assessment of concept proficiency, according to an example embodiment.

FIG. 22 shows a user interface displaying complete competency proficiency for a subject with student's mastery of the competencies, according to an example embodiment.

FIG. 23 shows a user interface showing a course view displaying the complete competency proficiency for a subject with student's mastery of the competencies by taxonomy course, according to an example embodiment.

FIG. 24 illustrates a user interface showing a comparative view of domain proficiency in a cohort of learners, according to an example embodiment.

FIG. 25 shows a user interface providing a suggested route for target destination competency for a learner, according to an example embodiment.

FIG. 26 shows a user interface for providing reroutes suggestions, according to an example embodiment.

FIG. 27 shows a matrix view of the competency model for a subject, according to an example embodiment.

FIG. 28 is an example computer system useful for implementing various embodiments.

### DETAILED DESCRIPTION

Provided herein are system, method and/or computer program product embodiments, and/or combinations and sub-combinations thereof, for providing adaptive learning paths based on specified learning goals and student competency profiles.

While the embodiments described herein are exemplified in the context of a smartphone/tablet application in communication with a server system, they are generally applicable to any system that provides the functionalities described herein, such as, by way of example, a web browser, standalone application, applet, special-purpose computer, etc.

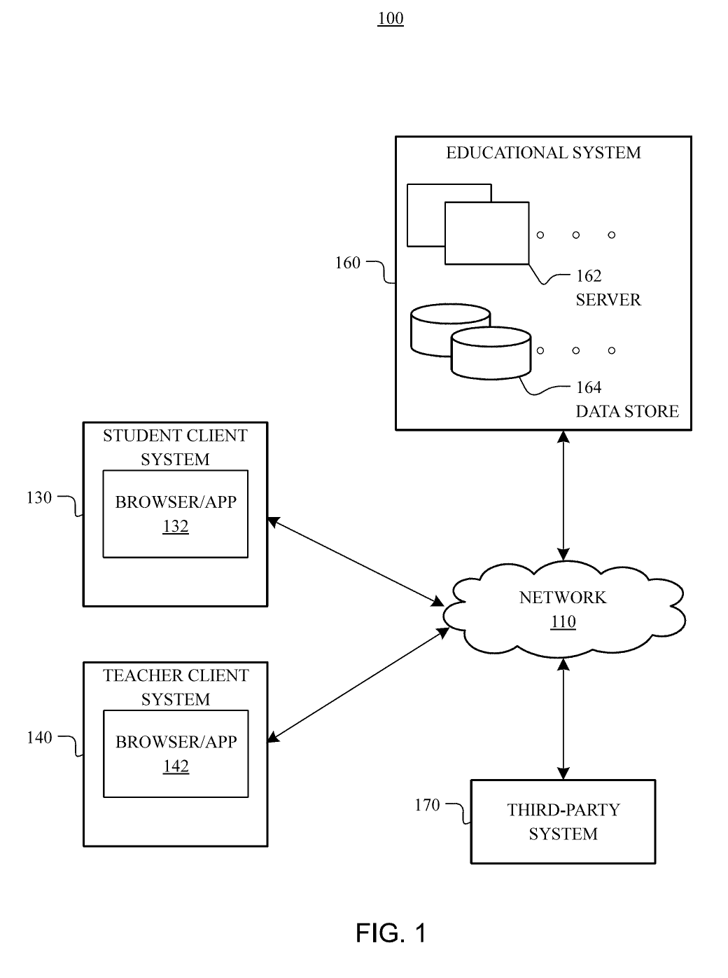

FIG. 1 illustrates an educational system environment 100, according to an example embodiment. A client system 130 connects to educational system 160 through a network 110. The network may be any communications network suitable for transmitting data between computing devices, such as, by way of example, a Local Area Network (LAN), a Wide Area Network (WAN), Metropolitan Area Network (MAN), Personal Area Network (PAN), the Internet, wireless networks, satellite networks, overlay networks, or any combination thereof. Client system 130 may be any computing device suitable for interacting with educational system 160, such as, by way of example, a personal computer, mobile computer, laptop computer, mobile phone, smartphone, personal digital assistant, or tablet computer. Educational system 160 may be any computing device or combination of devices suitable to provide online interfaces, such as, by way of example, server computers, database systems, storage area networks, web servers, application servers, or any combination thereof. As an example, one or more servers 162 may store and access data from one or more data stores 164, and may further communicate with one or more clients 130 to serve requests and generate a graphical user interface for display in client device 130.

A user of client system 130 may interact with educational system 160 through any suitable graphical user interface 132, such as, by way of example, an application, web browser, web application, mobile application, etc. Each user may establish an account and profile with educational system 160. Additionally, educational system 160 may redirect client 130 to access content from one or more third-party systems. As an example, educational system 160 may provide client 130 a link or may display media hosted by a third-party system 170.

Educational system 160 may provide a plurality of interfaces for various user types. For example, a student may use a learner interface for navigating educational offerings, generating learning routes, and consuming educational content, among other things, as described throughout. A teacher may user a teacher interface for interacting with students, reviewing student progress, creating learning resource collections, among other things.

Educational system 160 may further provide Application Programming Interfaces (APIs) for creating educational experiences for other users. The information, metadata, taxonomies and concept graphs described throughout this disclosure can be specified by API users. As an example, an educational institution (e.g., School, University, Community College, etc.) may use educational system 160 to create learning journeys, courses, units, lessons, collections, and other learning constructs as described throughout this disclosure. API users may provide resources and assessments, or associated resources and assessments made available by educational system 160 with their courses. In addition, API users may specify taxonomy information specifying pre-requisites for the educational content provided, and educational standards information specifying what educational standards the content is meant to satisfy. In this manner, educational institutions may benefit from the functionalities of educational system 160, such as adaptive learning path generation, suggestion generation, supplementary resources, etc., as will be described throughout this disclosure.

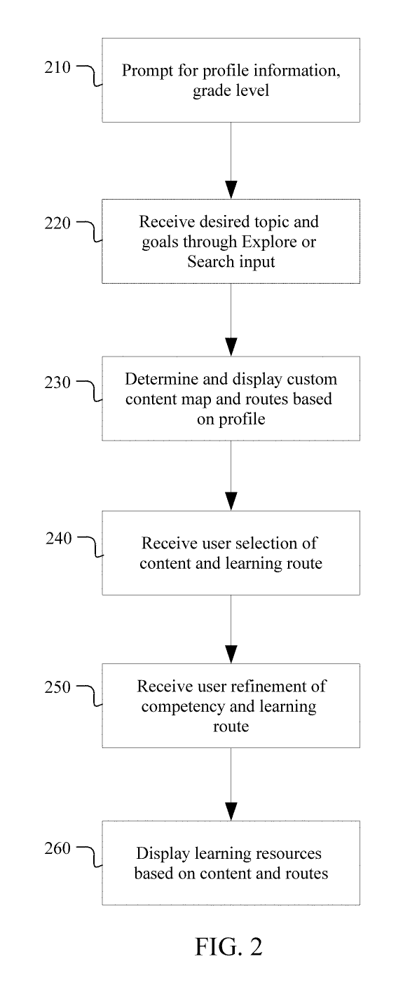

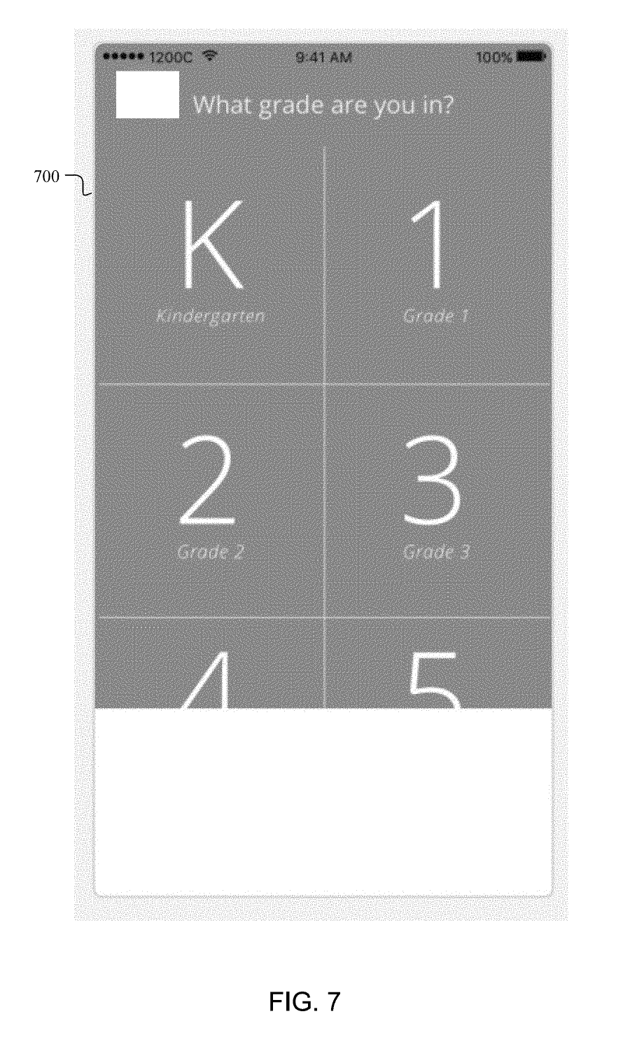

FIG. 2 is a flowchart of a method for providing adaptive learning paths based on specified learning goals and student competency profiles, according to an example embodiment. At step 210, educational system 160 obtains profile information about a learner, for example, by prompting the learner to input relevant information. Educational system 160 may also obtain the profile information from other sources, such as associated social-networking profiles, school information, etc. As shown in FIG. 7, a K-12 student may input the grade level the student is currently in. Once a learner has completed the user profile, the learner can navigate the rest of the application. Educational system 210 may then use profile information to select appropriate educational content to offer the learner.

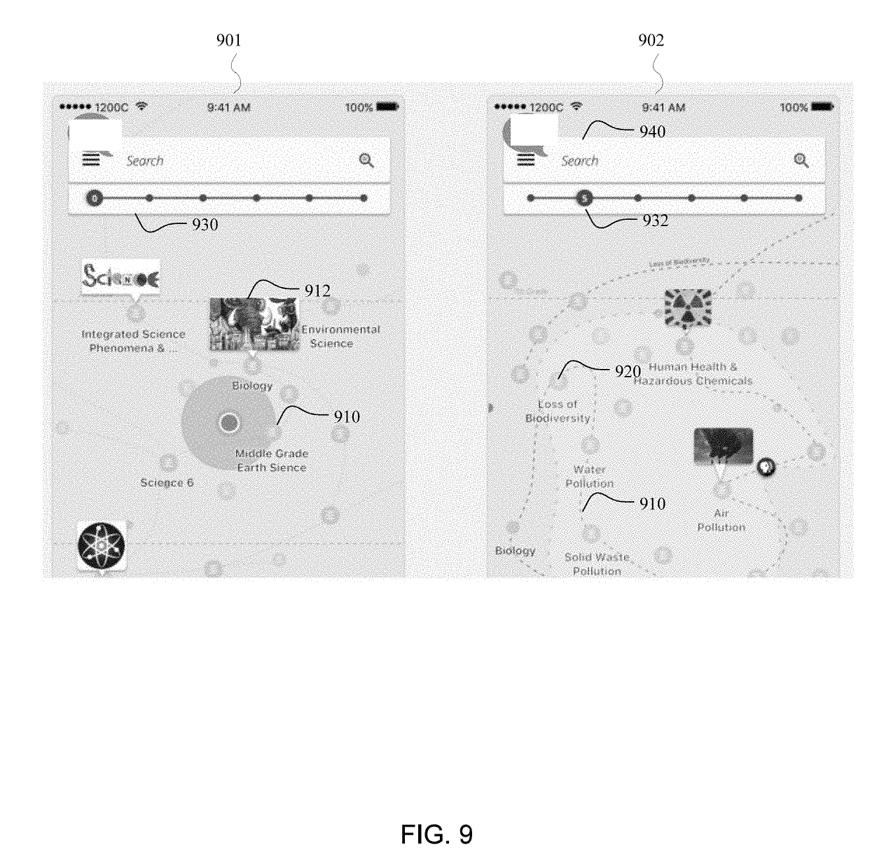

At step 220, educational system 160 may receive information related to desired educational topics or goals of the learner, for example, through its user interface. In particular embodiments, the interface may show a search bar 940 for entering topics of interest, as shown in FIG. 9. Search bar 940 may provide autocompletion suggestions based on educational contents available for the user and the user competency profile. In particular embodiments, a user interface may allow a user to browse through available topics through a navigation interface.

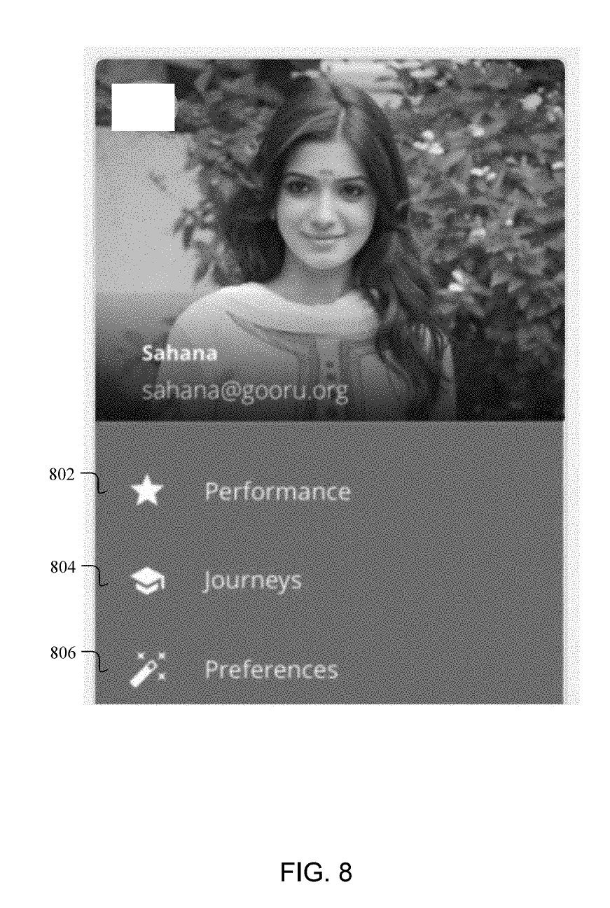

FIG. 8 shows a user interface for initiating navigation of an educational content portal, according to an example embodiment. In particular embodiments, a learner may navigate to a Performance Section 802, a Journeys Section 804, and a Preferences Section 806. Performance Section 802 may provide various progress and competency metrics associated with the user based on, for example, completion of learning activities, assessment scores, etc. Journeys Section 804 may provide interfaces to navigate learning offerings, create learning paths, and consume learning content. Preferences 806 may provide various customizable settings, such as specifying the type of learning experiences the user prefers.

At step 230, educational system 160 determine and display customized content map and routes based on profile. The content selected for display may be based on the learner's competency profile and analytics based on user data including, by way of example, assessment performance, educational activities completed, educational standards, etc. Educational system 160 may access a concept dependency graph and locate the user's current competency in the graph based on the user's competency profile. Educational system 160 may then find one or more paths from the user's current competency to the learning objective, and present them to the user.

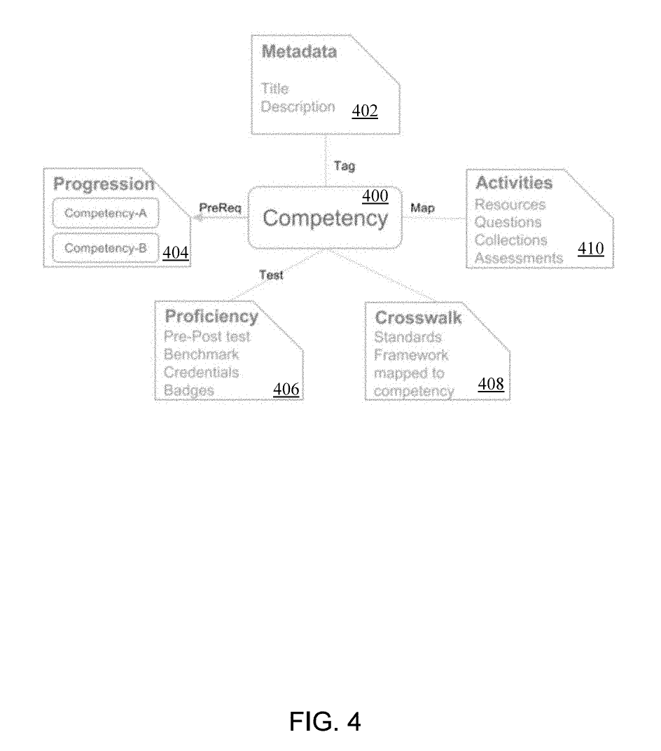

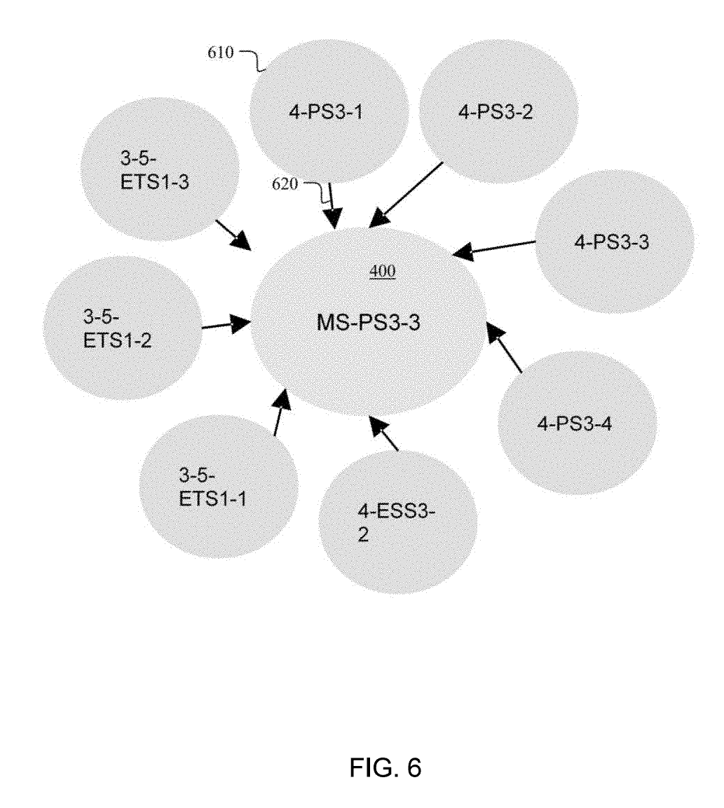

FIG. 4 a block diagram describing a subject matter competency model, according to an example embodiment. Educational system 160 may maintain a database of competencies with information on various subject matters. The information may allow educational system 160 to properly generate content suggestions and learning routes for learners. A competency 400 may include metadata 402 for identification, including a description of the subject matter that the competency describes. A competency 400 may further include information that indicates whether a learner is competent in the subject matter, and what are the requirements to become competent. In particular embodiments, a competency may be associated with a progression of prerequisites or other dependencies that describes what other competencies 404 (if any) a learner should have completed in before completing competency 400. In this manner, the competencies form a directed graph describing possible progressions to complete a competency, as illustrated in FIG. 6. A competency 400 may be associated with multiple other competencies 610 with a prerequisite relationship 610, indicating that the competencies 610 must be completed before completing competency 400.

A competency 400 may be associated with educational activities 410 (e.g., resources, questions, collections, assessments, etc.) that aid in the learning of the subject matter. Proficiency information 406 may be measured and recorded for the learner based on any suitable metrics, such as test results, benchmarks, credentials, badges earned, etc.

A competency 400 may also be associated with multiple educational standards frameworks in a standards table 408. In particular embodiments, educational system 160 generates a crosswalk table that maps educational standards from multiple sources to competencies in the competency database. Mapping multiple standards to a competency may aid in identifying relevant learning resources. As an example, educational system 160 may receive profile information describing a user as an 8^{th} grade student from California. The system 160 may search the competency database to identify competencies associated with California educational standards, finding, as an example, 8^{th} grade Earth Science competency in the competency database. System 160 may then identify in the standards table 408 other educational standards associated with the same competency (e.g., Texas standards for 8th grade Earth Science). In this manner, educational system 160 may aggregate sources tagged as complying with corresponding standards and offer additional relevant educational resources to learners and teachers operating under different standards.

In particular embodiments, educational system 160 may calculating a 3-tuple representing the subject competency information for the user, the 3-tuple including a value representing the subject, a value representing the one or more domains, and a value representing the one or more courses. The 3-tuple representation as part of the user's competency profile. Analogously, a learning objective associated with the user is also represented as a 3-tuple of a desired subject competency. In essence, the 3-tuples comprise a point in a 3-dimensional space, each point in the space representing an educational state. In this manner, educational system 160 may perform route planning to move the user from the current competency to a desired competency by finding a route between the two points in this 3-dimensional space. For example, based on the concept dependency graph, as described herein, educational system 160 may generate an ordered set of learning activities that establish a path between the subject competency 3-tuple and the learning objective 3-tuple.

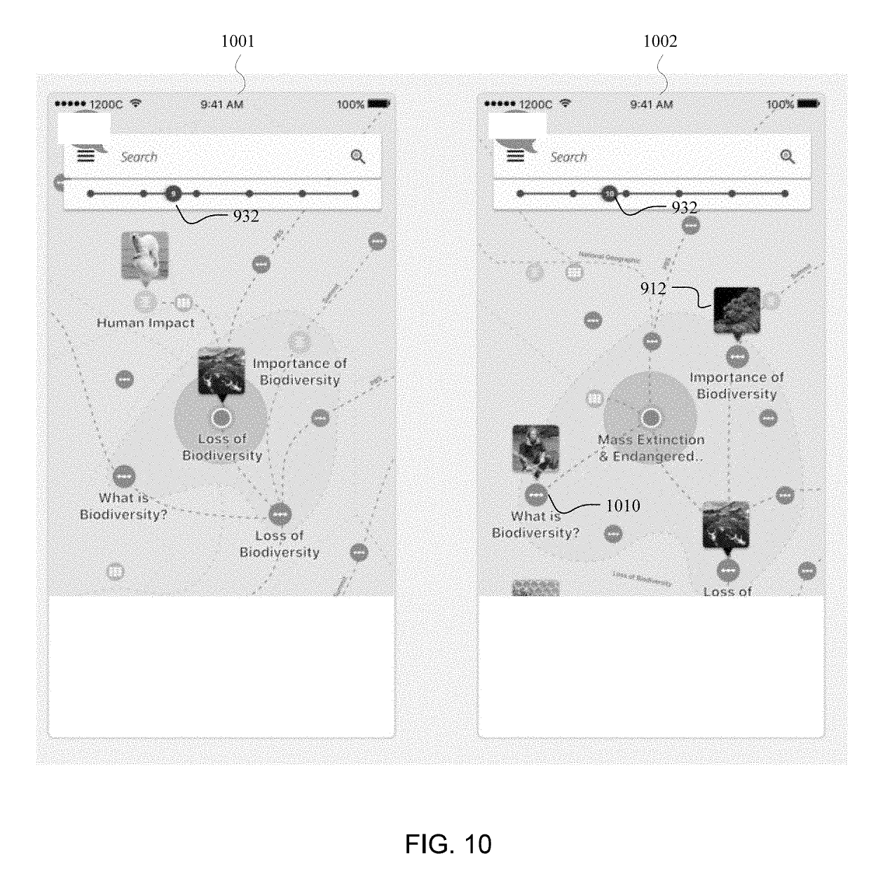

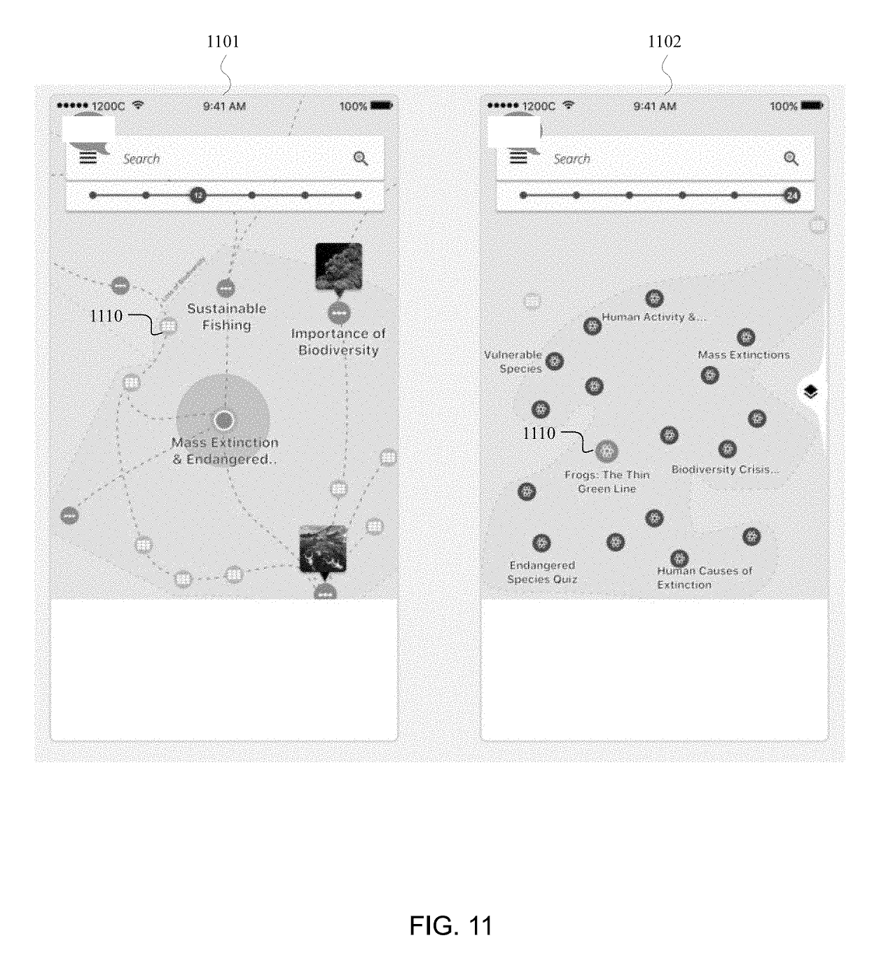

FIG. 9-11 shows a map interface for navigating an educational content portal, according to an example embodiment. In particular embodiments, educational system 160 may provide a map interface showing available content and dependencies among the content. As an example, interface 901 may show available courses 910 based on a user competency profile of an eight-grade student, e.g., (Earth Science, Biology, Environmental Science, etc.). The interface may further include a zooming mechanism 930 and zoom label 932. In particular embodiments, zooming into the map may dynamically reveal details of each available course, a shown in interface 902. As an example, an Environmental Science course may be comprised of multiple units 920, e.g., Loss of Biodiversity, Water Pollution, Air Pollution, etc. As the user zooms more and more into the map, additional details of each educational component are revealed. Furthermore, the map interface may show dependencies between educational components through paths 910. As an example, a visual route line may communicate that a student should study a Loss of Biodiversity unit first, then a Water Pollution unit second, followed by a Solid Waste Pollution unit third, etc. Furthermore, zooming into the map may provide additional details such as images 912 associated with each educational component.

As the map is further zoomed in, images associated with parent components may disappear and images related to child components appear, as shown in interfaces 901, 902, 1001, and 1002. In this manner, educational concepts of lower granularity may be shown, i.e., courses 910 composed of units 920, units 920 composed of lessons 1010, and lessons composed of resources 1110, etc. As shown in FIG. 9-11, an Environmental Science course may contain a Loss of Biodiversity unit, which in turn includes a What is Biodiversity lesson, which in turn contains a Frogs: The Thin Green Line resource. Resources 1110 may be any relevant educational resource for learning, such as, by way of example, video lectures, audio lectures, documentaries, podcasts, textbook readings, quizzes, articles, etc. Resources may be provided through the educational system interface directly, or via a referral such as link to third-party resources (e.g., National Geographic, Science Journal, Wikipedia, etc.).

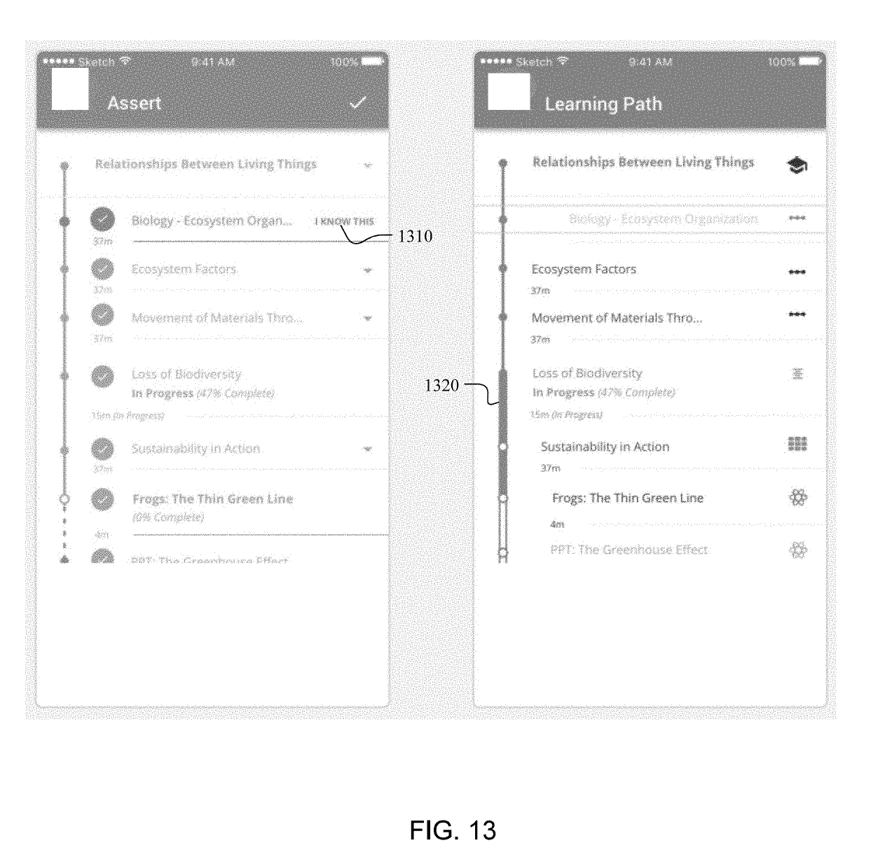

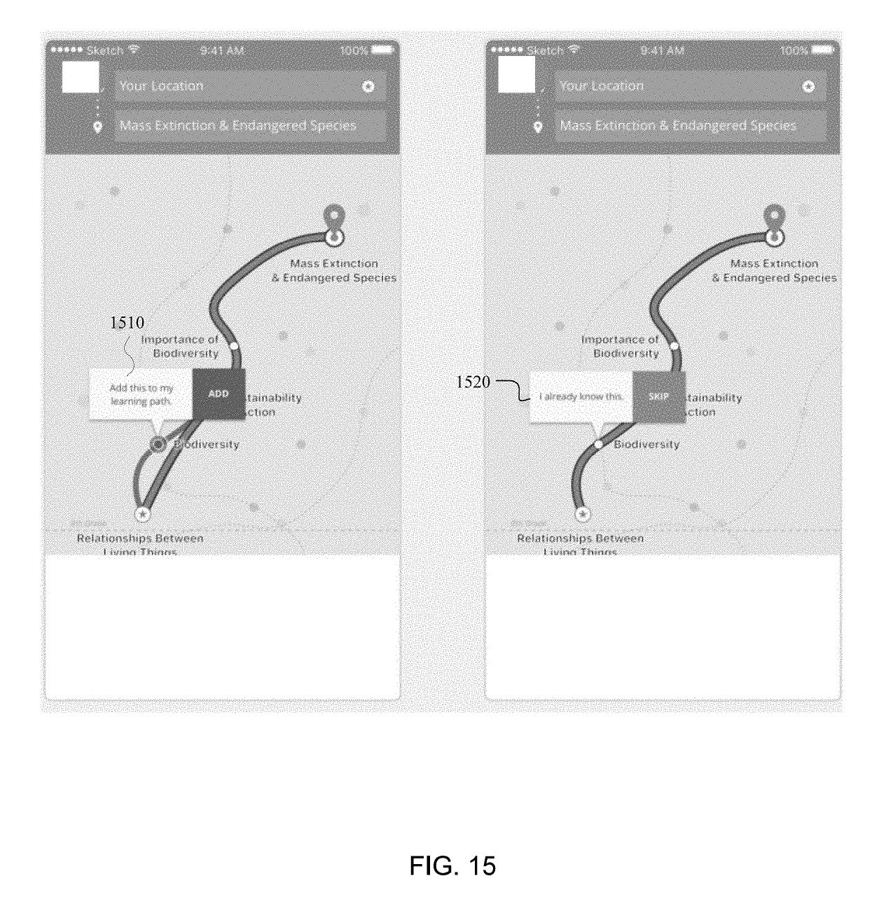

At step 240, educational system 160 receives user selection of content and learning routes. System 160 may receive selections through the navigation interface, the search interface, or any other suitable means. As an example, a student may browse the map interface and select a one or more of the courses or collections displayed. In particular embodiments, a user may select a learning destination, i.e., a competency that the user wishes to complete. Educational system 160 may then suggest a route for the user to achieve the desired competency. FIG. 13 shows a list-view user interface 1320 showing an adaptive learning route, according to an example embodiment. FIG. 15 shows a map view interface showing an adaptive learning route, according to an example embodiment.

At step 250, educational system 160 receives user refinement of competency and learning routes. As shown in FIG. 13, a user may adjust the learning route by adding or removing points along the route. For example, a user may indicate in an interface that the user is already familiar with a unit and is competent in the subject matter, as shown in 1310 for a list-view interface and element 1520 for a map interface. In another example, a user may add points along the route or change points to create an alternate route, as shown in 1510 on a map interface. In this manner, the map interface allows the user to easily visualize multiple alternate courses/units/lessons that can be completed to become competent in a particular subject matter.

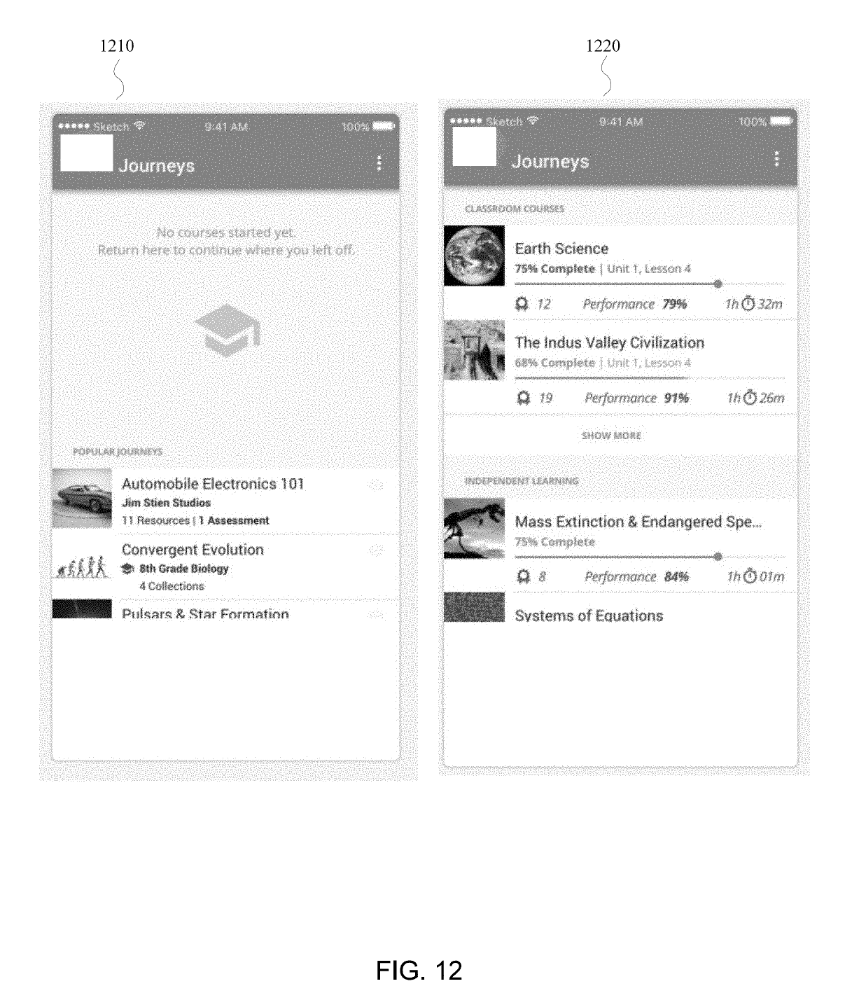

At step 260, educational system 160 offers learning resources based on the user's selected route. FIG. 12 shows a user interface for accessing learning journeys based on selected routes, according to an example embodiment. Element 1210 shows an interface where a user has yet to select a route. Element 1220 shows a listing of journeys the user has initiate, along with information related to completion and current state of the journey.

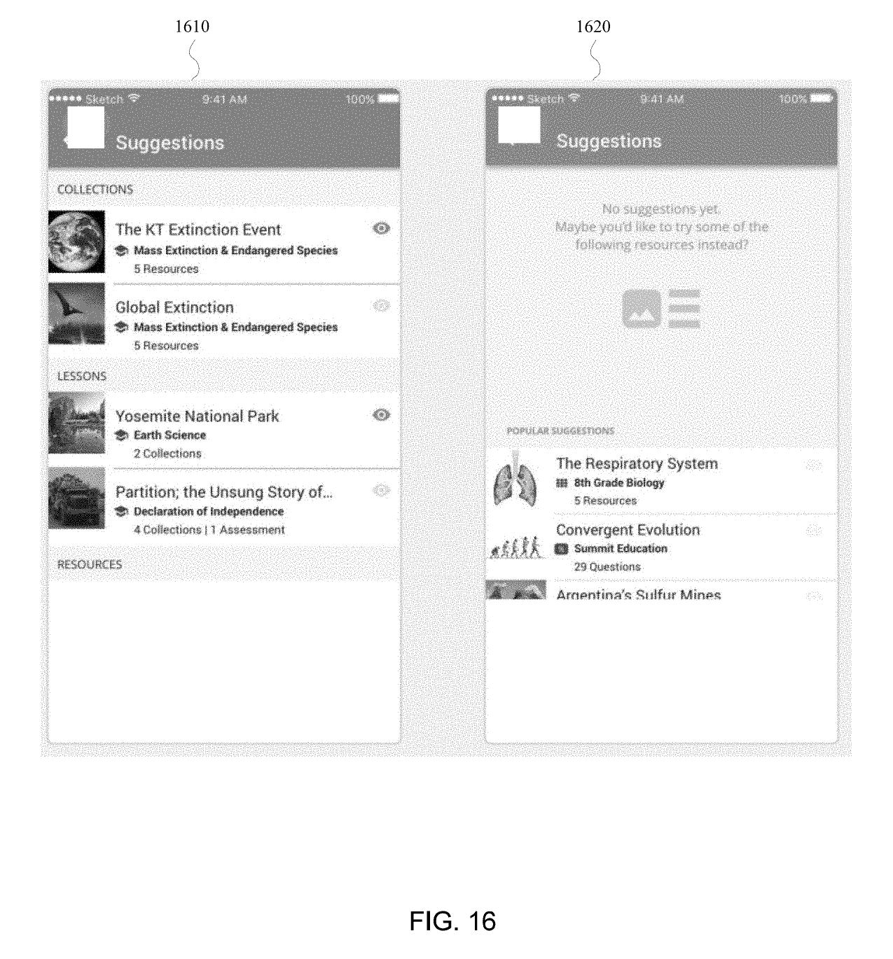

Educational system 160 may further offer suggestions to users for additional or complementary learning based on the user's competency profile. FIG. 16 shows an interface presenting suggestions for collections, lessons, or resources, according to an example embodiment. Suggestions may be specific to a user based on competency profile (1610) or general suggestions (1620).

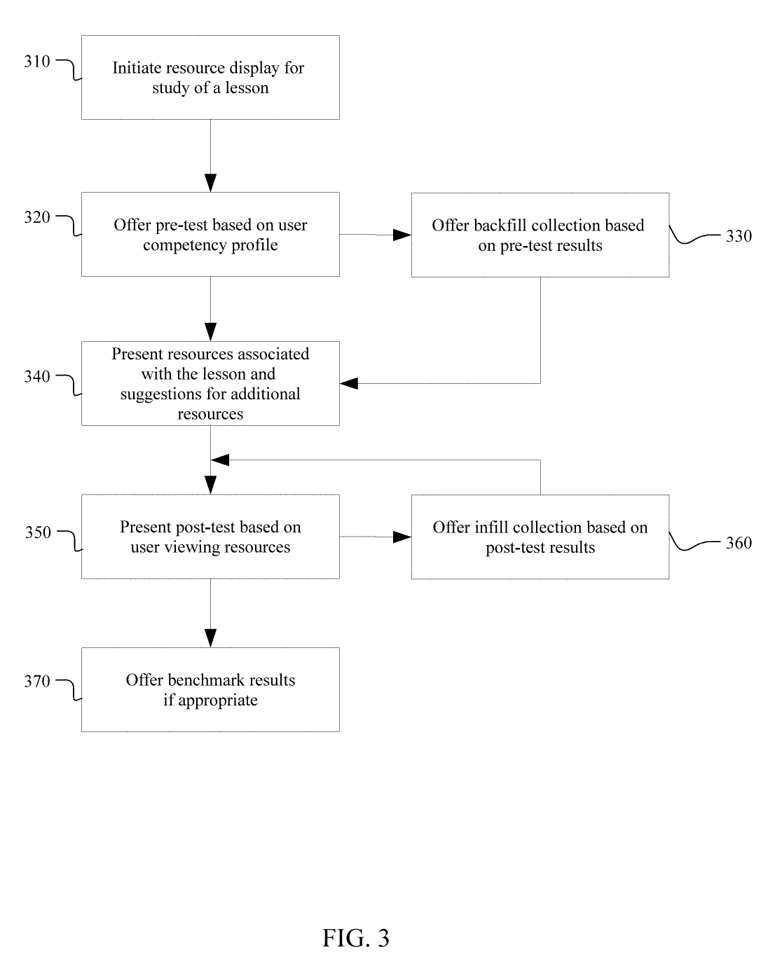

FIG. 3 is a flowchart of a method for providing suggestions and assessments for generating adaptive learning paths, according to an example embodiment. At step 310, educational system 160 initiates resource display for study of a lesson in response to a user input. At step 320, educational system 160 may offer one or more pre-tests based on a user competency profile. As an example, a pre-test may be offered that tests whether the user has a sufficient understanding of pre-requisite subject matter to continue studying the selected content. If the pre-test results indicate the user does not have the sufficient understanding, at step 330 educational system 160 offers one or more backfill collections of resources that provides the relevant learning. At step 340, educational system 160 presents resources associated with the lesson and suggestions for additional resources. Learners may elect to study additional related content along their personalized learning path. At step 350 educational system 160 presents one or more post-tests related to the subject matter visited. At step 360, educational system 160 offers an infill collection based on post-test results. As an example, educational system 160 may determine the user performed unsatisfactorily on a particular topic included in a post-test, and based on that offer a collection of resources associated with the topic. At step 370, educational system 160 offers results, such as, for example, a score and benchmarks comparing the learner performance to other learners.

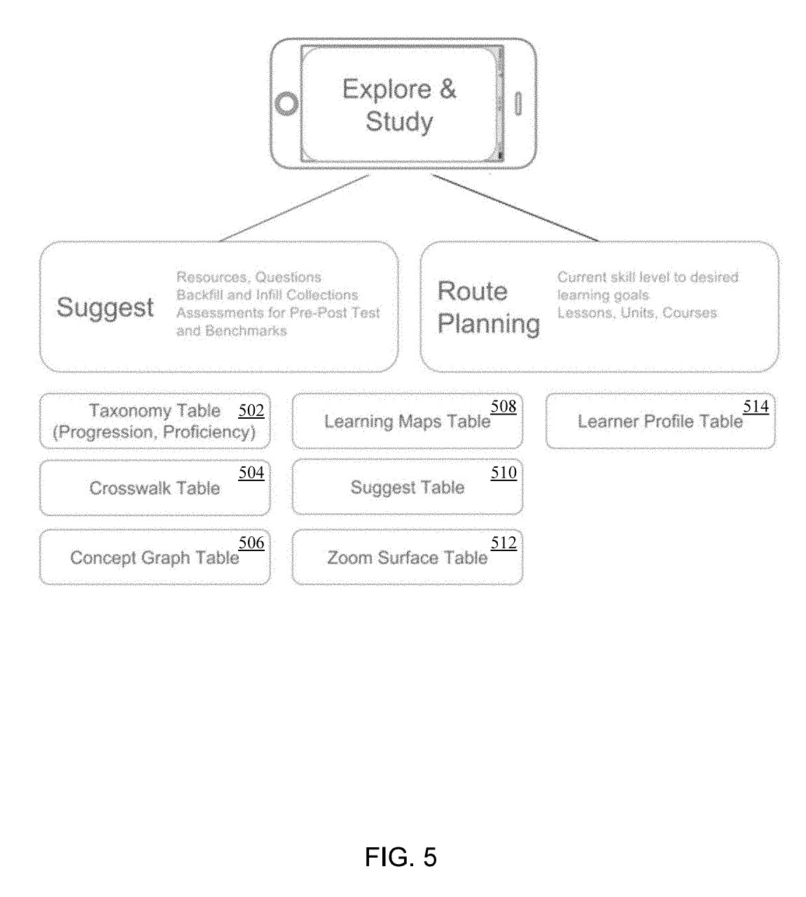

As explained above with reference to FIGS. 2 and 3, educational system 160 determines what content to present and suggest based on a user's competency profile. FIG. 5 is a block diagram describing the generation and presentation of suggestions and route planning for an adaptive learning path, according to an example embodiment. Educational system 160 may determine content to present and suggest based on information from some or all of taxonomy table 502, a crosswalk table 504, a concept graph table 506, learning maps table 508, suggest table 510, zoom surface table 512, and learner competency profile 514. Taxonomy table 502 contains hierarchical information describing topics and subject matter of an educational context. As an example, taxonomy table 502 may contain concepts taught during K-12 education in a taxonomy that goes from Grade>Courses>Units>Lessons. In another example, a university may generate a taxonomy table 502 with a hierarchy that goes from Degree>Major>Courses>Units>Lessons. Crosswalk table 504 may include information that correlate standards across multiple educational entities. As an example, crosswalk table 504 may crosswalk the educational standards of all 50 states in the United States and align them with the taxonomy in taxonomy table 502. In this manner, educational system 160 can present content and suggestions that are relevant to learners adhering to any particular educational standard.

Concept graph table 506 may store a graph describing the relationships between concepts. As an example, concept graph table 506 may store dependencies between concepts to create a graph that links concepts with their prerequisite concepts. Learning maps table 508 and zoom surface 512 may store information for generating the maps interface. As an example, learning maps table 508 may contain information associated with the content of map tiles based on the user's competency profile and topic of interest. Zoom surface 512 may contain information on the granular content at various zoom levels. Suggest table 510 may contain further information needed to make suggestions. As an example, suggest table 510 may link to alternate resources for supplemental learning, record adoption of previous suggestions, etc.

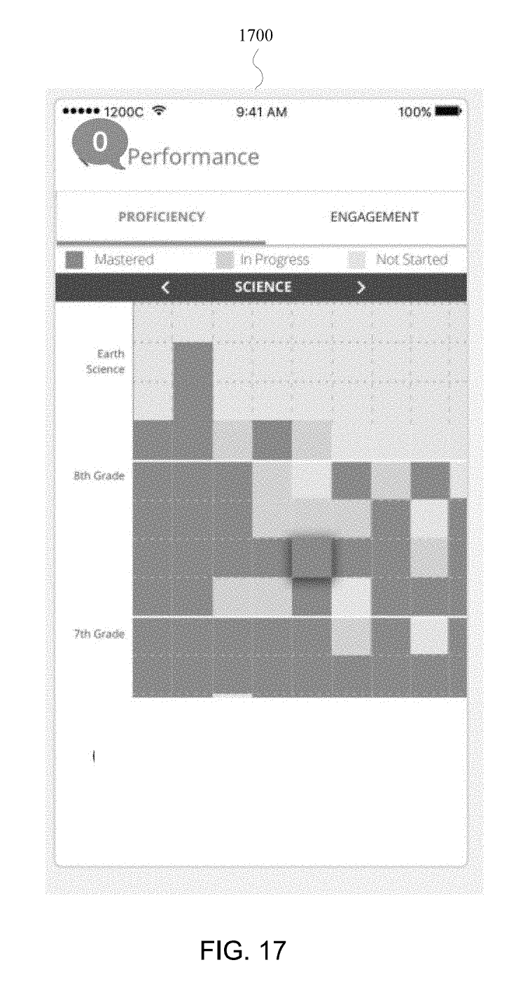

FIG. 17 shows a user interface for viewing a concept proficiency matrix, according to an example embodiment. In particular embodiments, educational system 160 may present a learner with various interfaces for evaluating his/her performance. As an example, a Performance section 802 of the application may display an interface 1700 showing the learner's progress in various competencies. In the example shown, a competency matrix show a status of “Mastered,” “In Progress,” or “Not Started” for various competencies and topics. A vertical axis may correspond to the level of competency in the K-12 context (e.g., 7^{th} grade, 8^{th} grade, etc.) while the horizontal axis corresponds to various subject matters or topics.

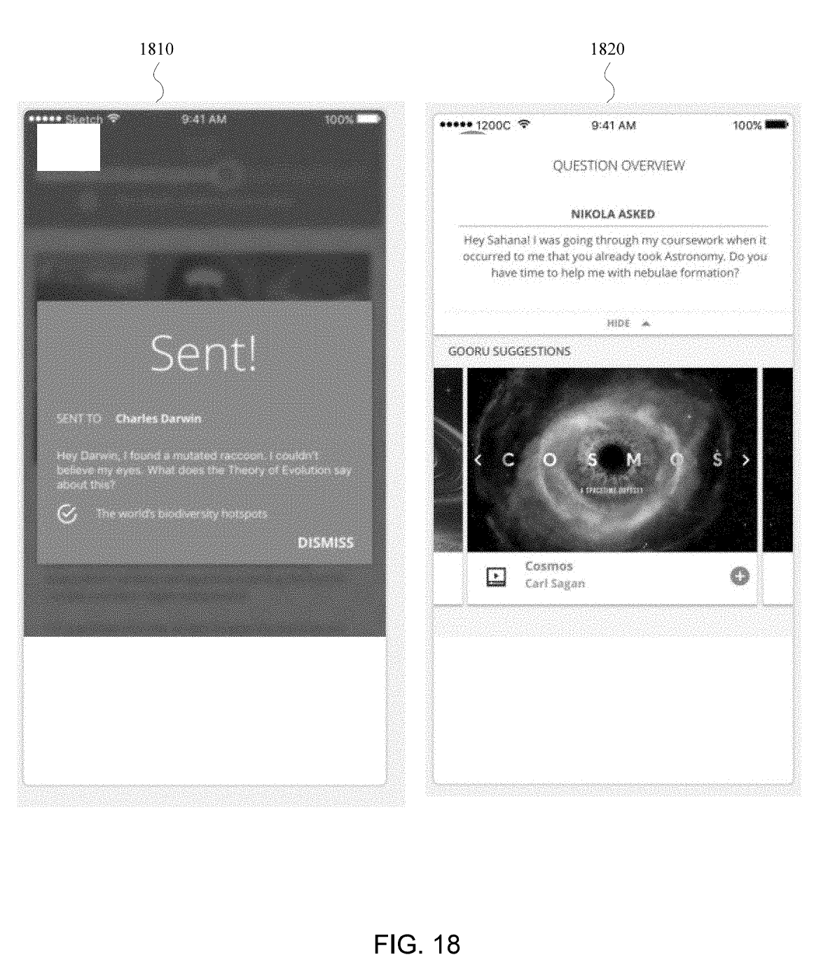

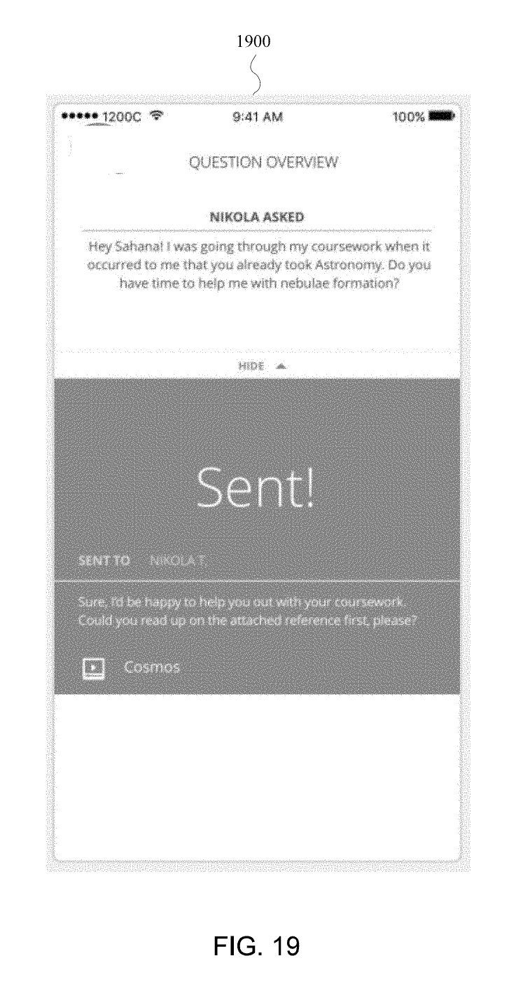

FIG. 18 shows a user interface for communicating and sharing content with other users of a learning environment, according to an example embodiment. In particular embodiments, educational system 160 may provide personalized suggestions for engagement between students, colleagues, and teachers. As an example, a learner may send messages to (1810) or receive message from (1820 other learners or teachers. Educational system 160 may provide content or resource suggestions based on an analysis of the message and the user competency profile, as shown in 1820. Learners or teachers may share also share the suggestions with each other, as shown in FIG. 19.

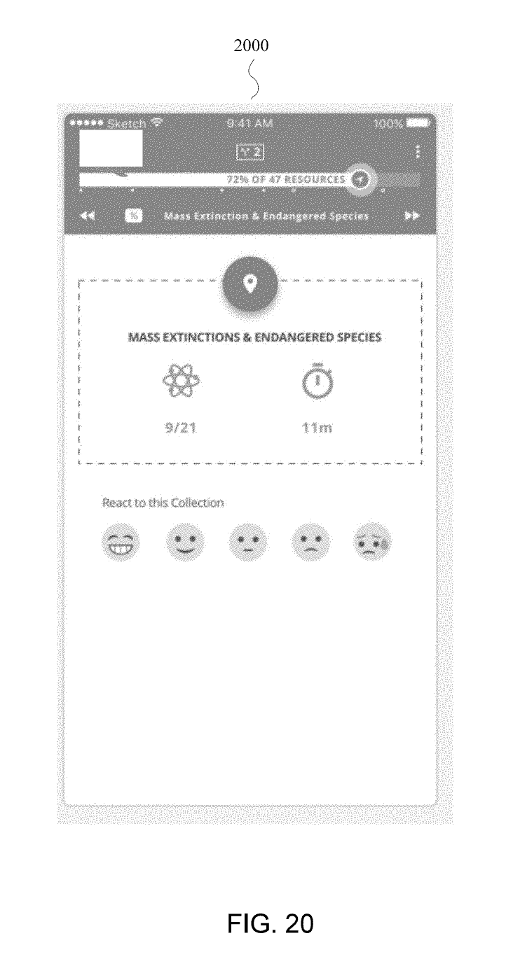

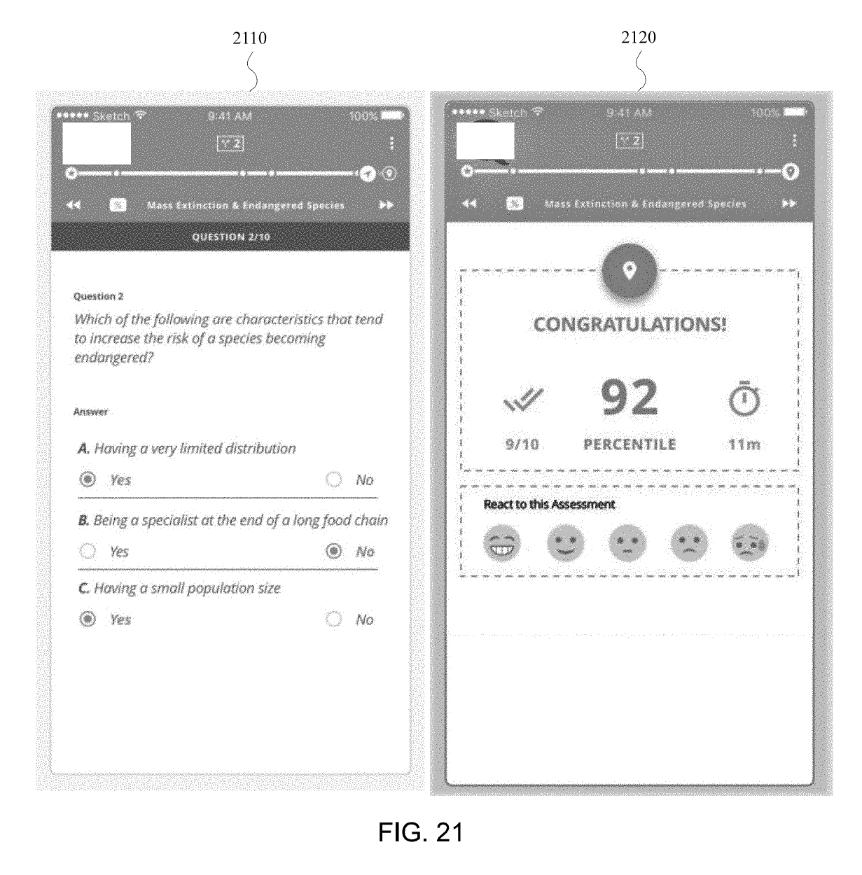

FIG. 20 shows a user interface for providing feedback related to a learning experience, according to an example embodiment. FIG. 21 shows a user interface for providing an assessment of concept proficiency, according to an example embodiment.

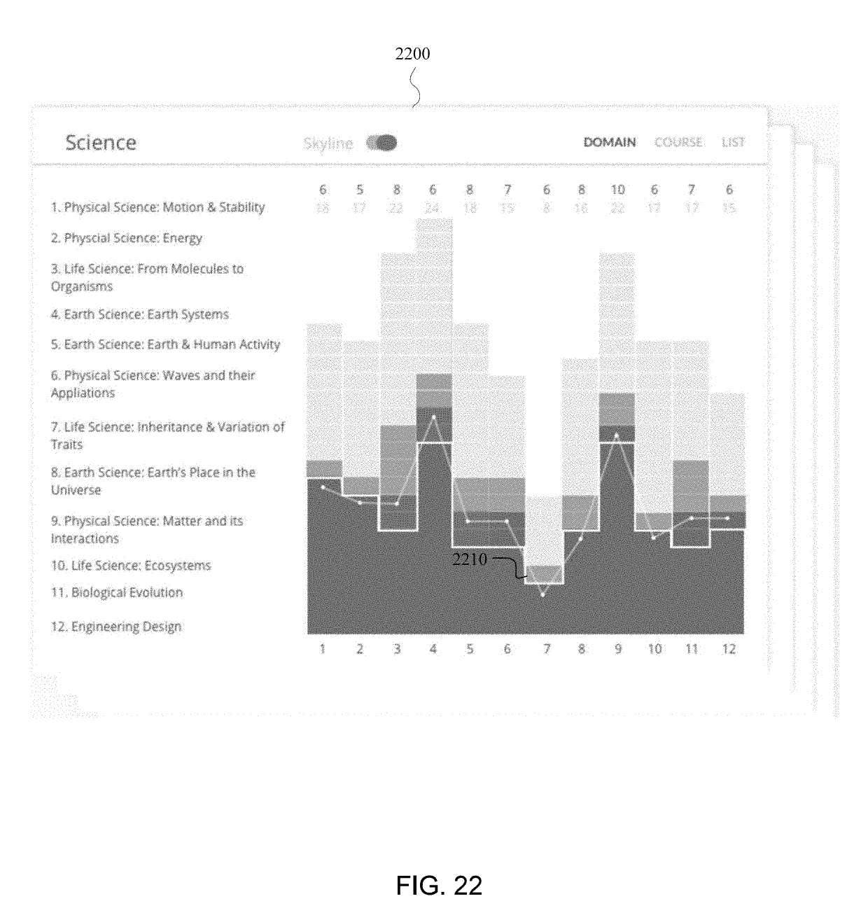

FIG. 22 shows a user interface 2200 displaying complete competency proficiency for a subject with student's mastery of the competencies, according to an example embodiment. In particular embodiments, the interface of FIG. 22 is a domain view, where domains in a subject are displayed along the x-axis with all the competencies in a domain along the y-axis as individual cells stacked one above the other. Different colors may be used to indicate a learner's mastery of the competencies. As an example, (1) gray may indicate that the there is no evidence of any learning related to the competency; (2) light blue may indicate that there is evidence that student is studying learning activities related to the competency, but there is no evidence of the student having mastered it; and (3) dark blue may that the student has studied activities for that competency and there is evidence that the student has mastered the competency.

A skyline 2210 for a subject indicates the extent to which the student has mastered any given domain. The skyline is plotted on the domain view and can be turned on or off. The highest competencies in each domain that have evidence of mastery are connected together with a line to indicate the skyline. A snapshot of the competency proficiency chart can be created for any given time period and a series of these views provides the learner's progress through the competencies in the subject.

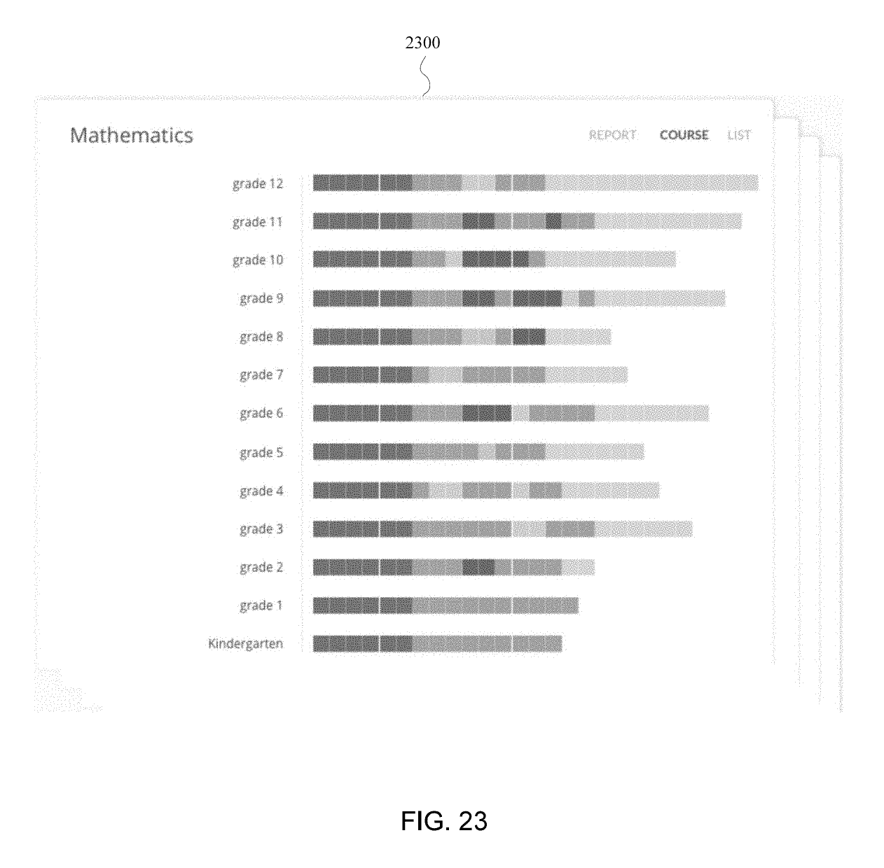

FIG. 23 shows a user interface 2300 showing a course view displaying the complete competency proficiency for a subject with student's mastery of the competencies by taxonomy course, according to an example embodiment. The taxonomy courses in a subject are displayed along the y-axis with all the competencies covered in that course along the x-axis as individual cells stacked one next to the other. Again, colors may be used to indicate learner's mastery of the competencies.

A snapshot of the competency proficiency chart can be created for any given time period and a series of these views provides the learner's progress through the competencies in the subject by course.

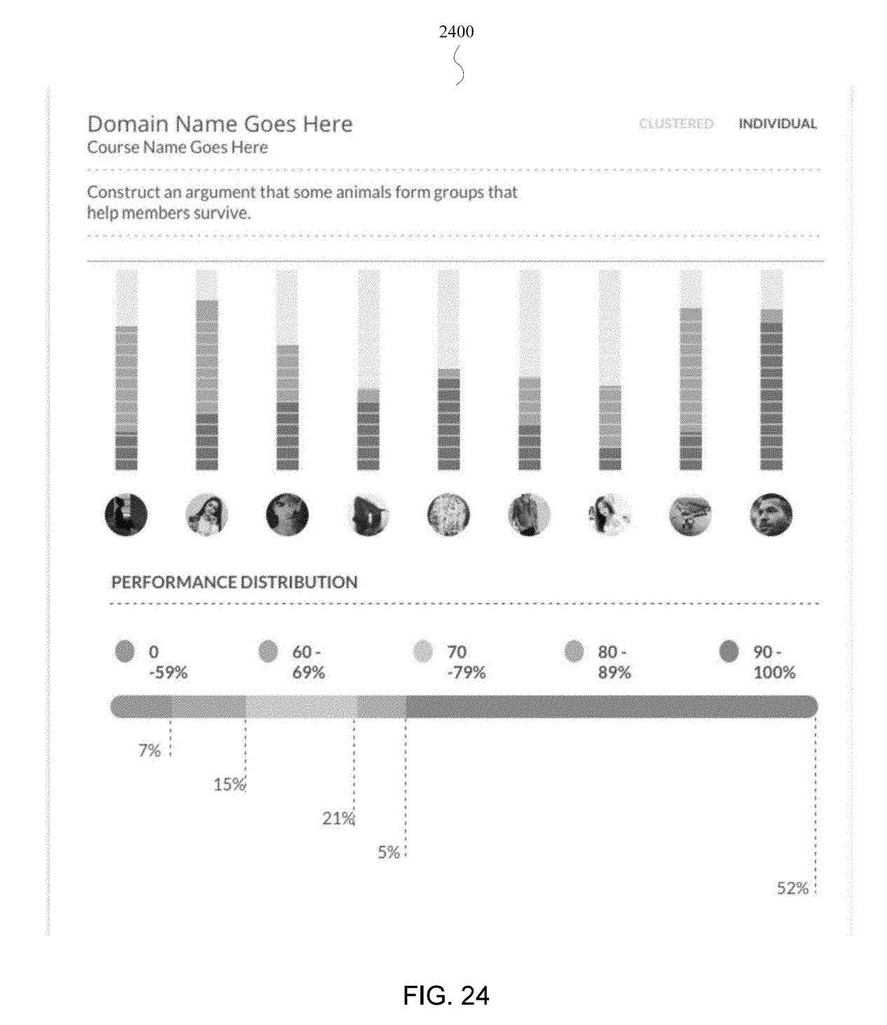

FIG. 24 illustrates a user interface 2400 showing a comparative view of domain proficiency in a cohort of learners, according to an example embodiment. Interface 2400 displays the competency profile for a domain for each learner in a cohort side-by-side. Interface 2400 also displays the average performance distribution for the cohort for the competencies covered in the domain.

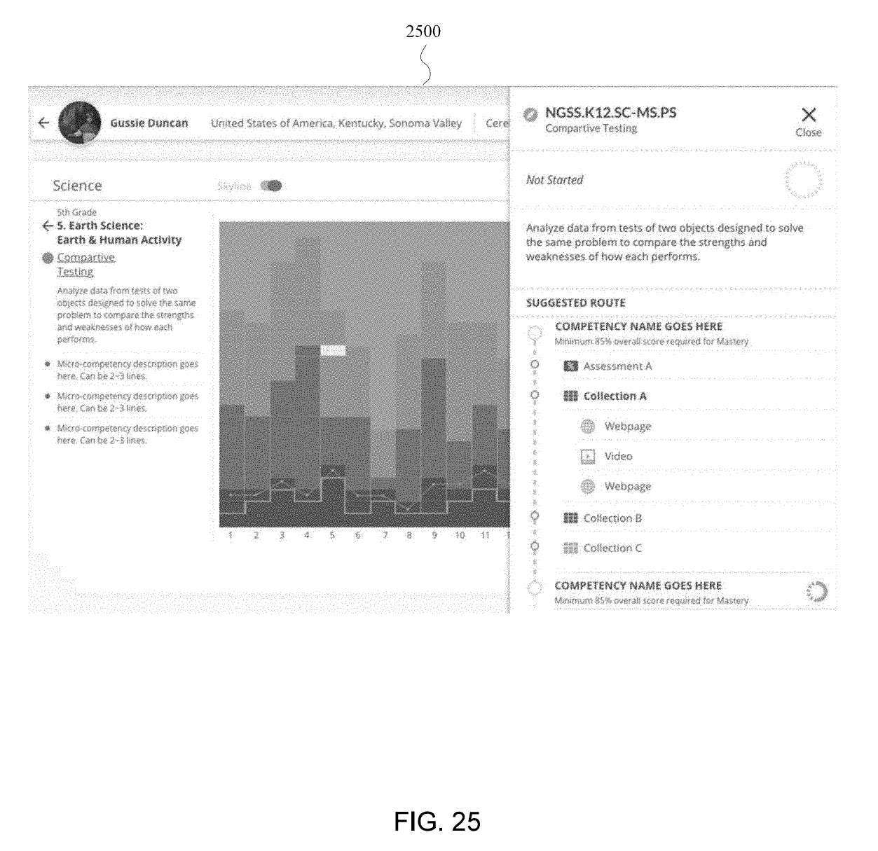

FIG. 25 shows a user interface 2500 providing a suggested route for target destination competency for a learner, according to an example embodiment. Based on a learner's competency profile, the system can provide a suggested learning path for any target competency that the learner wants to master. The system computes the learning path based on the student's proficiency to identify the competencies that the learner would need to study, and master, to be able to master the target competency. This computed path is called the suggested learning path. The learning path is a series of lessons comprising of learning activities that are suggested based on the student's profile. For each competency in the suggested route, the list of activities are shown in the pullout on the right.

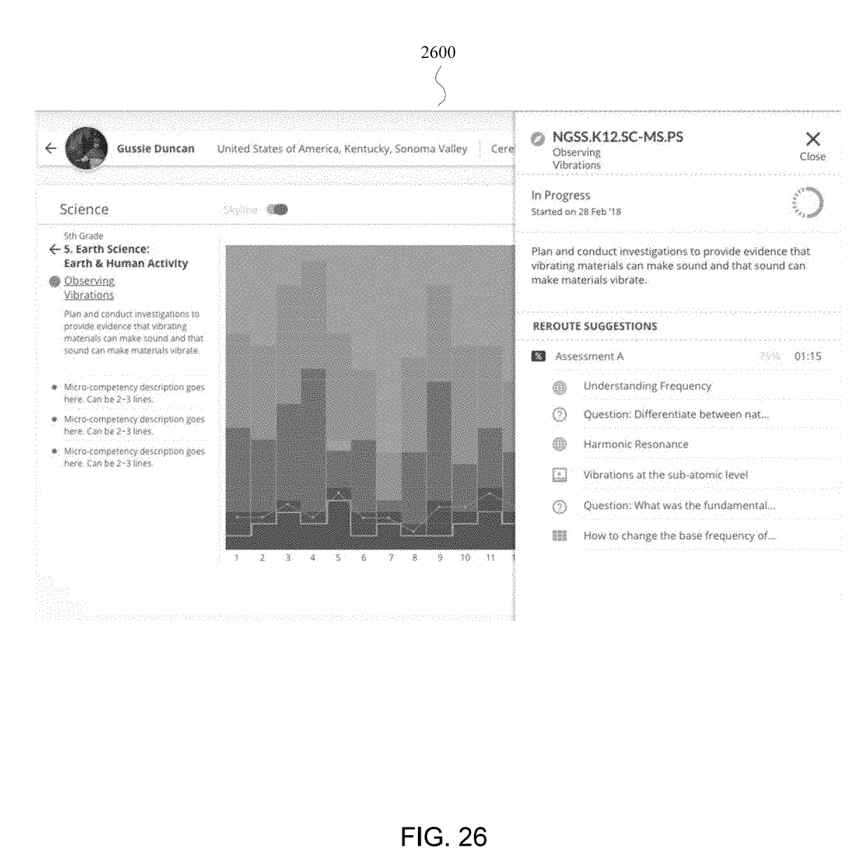

FIG. 26 shows a user interface 2600 for providing reroutes suggestions, according to an example embodiment. Based on a learner's performance in any competency that the learner is studying, the system may provide a suggestion as the learner goes through the learning activities. FIG. 26 below shows the list of possible suggestions that can be made to the learner for the selected competency that is under study.

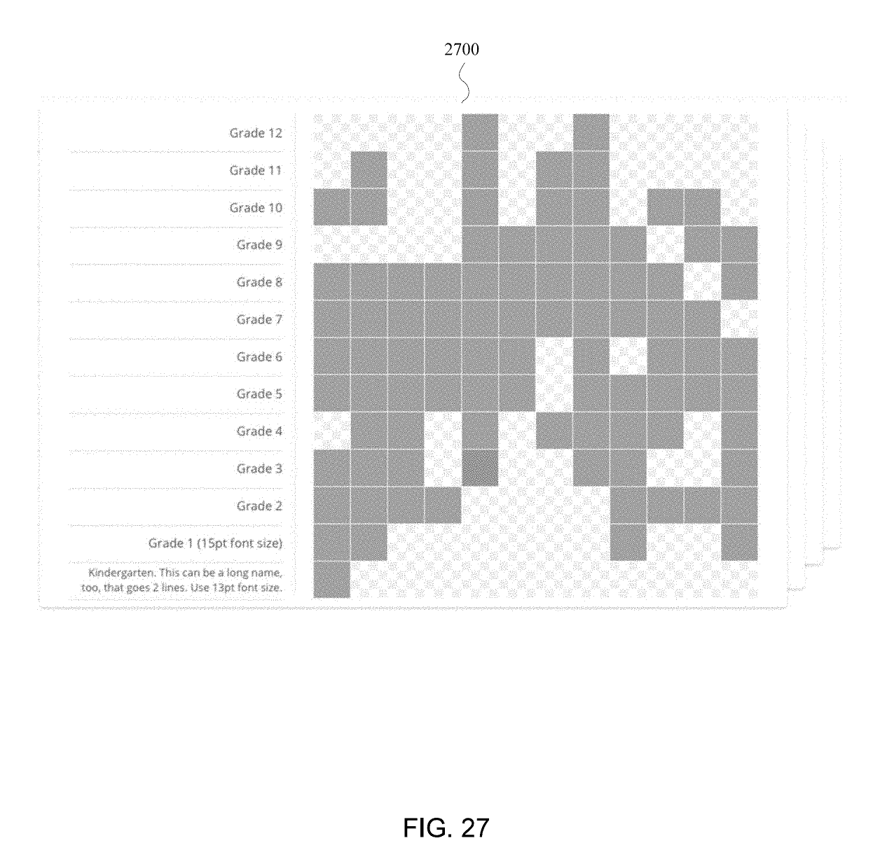

FIG. 27 shows a matrix view 2700 of the competency model for a subject, according to an example embodiment. The matrix view of the competency model for any subject displays the taxonomy courses along the y-axis and the domains along x-axis. The xy-plane has all the competencies in the subject. Each cell represents a list of competencies that are applicable for a given domain and taxonomy course. Along the z-axis all the subjects are represented.

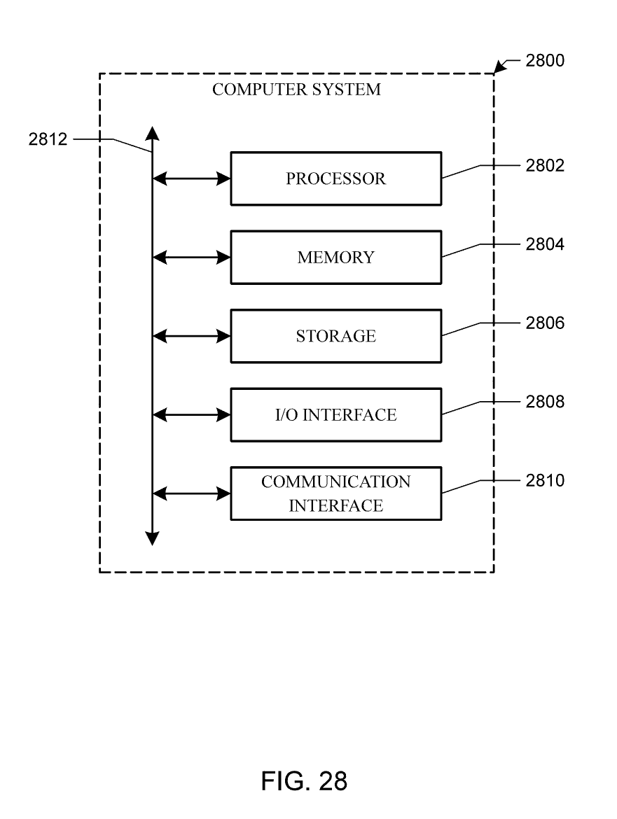

FIG. 28 illustrates an example computer system 2800. In particular embodiments, one or more computer systems 2800 perform one or more steps of one or more methods described or illustrated herein. In particular embodiments, one or more computer systems 2800 provide functionality described or illustrated herein. In particular embodiments, software running on one or more computer systems 2800 performs one or more steps of one or more methods described or illustrated herein or provides functionality described or illustrated herein. Particular embodiments include one or more portions of one or more computer systems 2800. Herein, reference to a computer system may encompass a computing device, and vice versa, where appropriate. Moreover, reference to a computer system may encompass one or more computer systems, where appropriate.

This disclosure contemplates any suitable number of computer systems 2800. This disclosure contemplates computer system 2800 taking any suitable physical form. As example, computer system 2800 may be an embedded computer system, a desktop computer system, a laptop or notebook computer system, a mainframe, a mobile telephone, a personal digital assistant (PDA), a server, a tablet computer system, or a combination of two or more of these. Where appropriate, computer system 2800 may include one or more computer systems 2800; be unitary or distributed; span multiple locations; span multiple machines; span multiple data centers; or reside in a cloud, which may include one or more cloud components in one or more networks. Where appropriate, one or more computer systems 2800 may perform without substantial spatial or temporal limitation one or more steps of one or more methods described or illustrated herein. As an example, one or more computer systems 2800 may perform in real time or in batch mode one or more steps of one or more methods described or illustrated herein. One or more computer systems 2800 may perform at different times or at different locations one or more steps of one or more methods described or illustrated herein, where appropriate.

In particular embodiments, computer system 2800 includes a processor 2802, memory 2804, storage 2806, an input/output (I/O) interface 2808, a communication interface 2810, and a bus 2812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 2802 includes hardware for executing instructions, such as those making up a computer program. As an example, to execute instructions, processor 2802 may retrieve (or fetch) the instructions from an internal register, an internal cache, memory 2804, or storage 2806; decode and execute them; and then write one or more results to an internal register, an internal cache, memory 2804, or storage 2806. In particular embodiments, processor 2802 may include one or more internal caches for data, instructions, or addresses. This disclosure contemplates processor 2802 including any suitable number of any suitable internal caches, where appropriate. In particular embodiments, processor 2802 may include one or more internal registers for data, instructions, or addresses. This disclosure contemplates processor 2802 including any suitable number of any suitable internal registers, where appropriate. Where appropriate, processor 2802 may include one or more arithmetic logic units (ALUs); be a multi-core processor; or include one or more processors 2802. Although this disclosure describes and illustrates a particular processor, this disclosure contemplates any suitable processor.

In particular embodiments, memory 2804 includes main memory for storing instructions for processor 2802 to execute or data for processor 2802 to operate on. As an example, computer system 2800 may load instructions from storage 2806 or another source (such as, for example, another computer system 2800) to memory 2804. Processor 2802 may then load the instructions from memory 2804 to an internal register or internal cache. To execute the instructions, processor 2802 may retrieve the instructions from the internal register or internal cache and decode them. During or after execution of the instructions, processor 2802 may write one or more results (which may be intermediate or final results) to the internal register or internal cache. Processor 2802 may then write one or more of those results to memory 2804. In particular embodiments, processor 2802 executes only instructions in one or more internal registers or internal caches or in memory 2804 (as opposed to storage 2806 or elsewhere) and operates only on data in one or more internal registers or internal caches or in memory 2804 (as opposed to storage 2806 or elsewhere). One or more memory buses (which may each include an address bus and a data bus) may couple processor 2802 to memory 2804. Bus 2812 may include one or more memory buses, as described below. In particular embodiments, memory 2804 includes random access memory (RAM). This RAM may be volatile memory, where appropriate Memory 2804 may include one or more memories 2804, where appropriate. Although this disclosure describes and illustrates particular memory, this disclosure contemplates any suitable memory.

In particular embodiments, storage 2806 includes mass storage for data or instructions. As an example, storage 2806 may include a hard disk drive (HDD), a floppy disk drive, flash memory, an optical disc, a magneto-optical disc, magnetic tape, or a Universal Serial Bus (USB) drive or a combination of two or more of these. Storage 2806 may include removable or non-removable (or fixed) media, where appropriate. Storage 2806 may be internal or external to computer system 2800, where appropriate. In particular embodiments, storage 2806 is non-volatile, solid-state memory. In particular embodiments, storage 2806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 2806 taking any suitable physical form. Storage 2806 may include one or more storage control units facilitating communication between processor 2802 and storage 2806, where appropriate. Where appropriate, storage 2806 may include one or more storages 2806. Although this disclosure describes and illustrates particular storage, this disclosure contemplates any suitable storage.

In particular embodiments, I/O interface 2808 includes hardware, software, or both, providing one or more interfaces for communication between computer system 2800 and one or more I/O devices. Computer system 2800 may include one or more of these I/O devices, where appropriate. One or more of these I/O devices may enable communication between a person and computer system 2800. As an example, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 2808 for them. Where appropriate, I/O interface 2808 may include one or more device or software drivers enabling processor 2802 to drive one or more of these I/O devices. I/O interface 2808 may include one or more I/O interfaces 2808, where appropriate. Although this disclosure describes and illustrates a particular I/O interface, this disclosure contemplates any suitable I/O interface.

In particular embodiments, communication interface 2810 includes hardware, software, or both providing one or more interfaces for communication (such as, for example, packet-based communication) between computer system 2800 and one or more other computer systems 2800 or one or more networks. As an example, communication interface 2810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 2810 for it. As an example, computer system 2800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 2800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 2800 may include any suitable communication interface 2810 for any of these networks, where appropriate. Communication interface 2810 may include one or more communication interfaces 2810, where appropriate. Although this disclosure describes and illustrates a particular communication interface, this disclosure contemplates any suitable communication interface.

In particular embodiments, bus 2812 includes hardware, software, or both coupling components of computer system 2800 to each other. As an example, bus 2812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 2812 may include one or more buses 2812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The breadth and scope of the invention should not be limited by any of the above-described exemplary embodiments, but should be defined only in accordance with the following claims and their equivalents.

What is claimed is:

1. A computer-implemented method comprising:
receiving subject competency information associated with a user's degree of study of a learning subject, wherein the subject competency information comprises one or more degrees of study for one or more domains and one or more degrees of study for one or more courses, the domains and courses related to the learning subject;
calculating a 3-tuple representing the subject competency information for the user, the 3-tuple including a value representing the subject, a value representing the one or more domains, and a value representing the one or more courses;
storing the 3-tuple representation as part of a competency profile associated with the user;
receiving a learning objective associated with the user, the learning objective comprising a 3-tuple of a desired subject competency;
selecting, based on a concept dependency graph, an ordered set of learning activities that establish a path between the subject competency 3-tuple and the learning objective 3-tuple, wherein references to the learning activities are stored in a learning activities table associated with the concepts in the concept dependency graph; and
sending information related to the learning activities to the user.

2. The method of claim 1, further comprising:
sending the ordered set of learning activities to the user for display in a navigation interface;
receiving a change in the ordered set of learning activities from the user.

3. The method of claim 1, further comprising:
receiving updated subject competency information from the user;
updating the competency profile based on the updated subject competency information; and
sending a new set of ordered learning activities based on the updated competency profile.

4. The method of claim 1, further comprising:
providing one or more assessments associated with one or more of the learning activities; and
providing one or more additional learning activities based on the results of the assessment.

5. The method of claim 1, wherein the navigation interface comprises a map interface displaying the learning activities and the path.

6. The method of claim 1, wherein the learning activities comprise at least one of a text, a video, or an audio recording.

7. The method of claim 1, further comprising:
receiving the concept dependency graph and the learning activities table from a second user.

8. A system, comprising:
a memory; and
at least one processor coupled to the memory and configured to:
receive subject competency information associated with a user's degree of study of a learning subject, wherein the subject competency information comprises one or more degrees of study for one or more domains and one or more degrees of study for one or more courses, the domains and courses related to the learning subject;
calculate a 3-tuple representing the subject competency information for the user, the 3-tuple including a value representing the subject, a value representing the one or more domains, and a value representing the one or more courses;
store the 3-tuple representation as part of a competency profile associated with the user;
receive a learning objective associated with the user, the learning objective comprising a 3-tuple of a desired subject competency;
select, based on a concept dependency graph, an ordered set of learning activities that establish a path between the subject competency 3-tuple and the learning objective 3-tuple, wherein references to the learning activities are stored in a learning activities table associated with the concepts in the concept dependency graph; and
send information related to the learning activities to the user.

9. The system of claim 8, the at least one processor further configured to:
send the ordered set of learning activities to the user for display in a navigation interface;
receive a change in the ordered set of learning activities from the user.

10. The method of claim 8, the at least one processor further configured to:
receive updated subject competency information from the user;
update the competency profile based on the updated subject competency information; and
send a new set of ordered learning activities based on the updated competency profile.

11. The method of claim 8, the at least one processor further configured to:
provide one or more assessments associated with one or more of the learning activities; and
provide one or more additional learning activities based on the results of the assessment.

12. The method of claim 8, wherein the navigation interface comprises a map interface displaying the learning activities and the path.

13. The method of claim 8, wherein the learning activities comprise at least one of a text, a video, or an audio recording.

14. The method of claim 8, the at least one processor further configured to:
receiving the concept dependency graph and the learning activities table from a second user.

15. A tangible computer-readable device having instructions stored thereon that, when executed by at least one computing device, causes the at least one computing device to perform operations comprising:
receiving subject competency information associated with a user's degree of study of a learning subject, wherein the subject competency information comprises one or more degrees of study for one or more domains and one or more degrees of study for one or more courses, the domains and courses related to the learning subject;
calculating a 3-tuple representing the subject competency information for the user, the 3-tuple including a value representing the subject, a value representing the one or more domains, and a value representing the one or more courses;
storing the 3-tuple representation as part of a competency profile associated with the user;
receiving a learning objective associated with the user, the learning objective comprising a 3-tuple of a desired subject competency;
selecting, based on a concept dependency graph, an ordered set of learning activities that establish a path between the subject competency 3-tuple and the learning objective 3-tuple, wherein references to the learning activities are stored in a learning activities table associated with the concepts in the concept dependency graph; and
sending information related to the learning activities to the user.

16. The computer-readable device of claim 15, the operations further comprising:
sending the ordered set of learning activities to the user for display in a navigation interface;
receiving a change in the ordered set of learning activities from the user.

17. The computer-readable device of claim 15, the operations further comprising:
receiving updated subject competency information from the user;
updating the competency profile based on the updated subject competency information; and
sending a new set of ordered learning activities based on the updated competency profile.

18. The computer-readable device of claim 15, the operations further comprising:
providing one or more assessments associated with one or more of the learning activities; and
providing one or more additional learning activities based on the results of the assessment.

19. The computer-readable device of claim 15, wherein the navigation interface comprises a map interface displaying the learning activities and the path.

20. The computer-readable device of claim 15, wherein the learning activities comprise at least one of a text, a video, or an audio recording.
